(19) United States
(12) Patent Application Publication
(10) Pub. No.: US 2013/0313845 A1
(43) Pub. Date: Nov. 28, 2013

(54) Holder for a Flat Plate Such as a Tablet Computer

(71) Applicant: Richard Pedde, Regina (CA)

(72) Inventor: Richard Pedde, Regina (CA)

(21) Appl. No.: 13/985,782

(22) PCT Filed: Mar. 2, 2012
(86) PCT No.: PCT/CA2012/050128

§ 371 Date: Aug. 15, 2013

Related U.S. Application Data
(60) Provisional application No. 61/448,946, filed on Mar. 3, 2011.

(51) Int. Cl. F16M 13/04

(52) U.S. Cl. CPC F16M 13/04
USPC 294/137

(57) ABSTRACT

A holder for a tablet computer such as an IPAD is formed by a sheet of a foamed elastic material extending over substantially the whole of the rear face flat adjacent to and parallel to the rear face of the flat plate. The sheet is held in place by an edge grip member around the edge of the sheet and shaped to engage the edge of the plate to hold the sheet at the rear face. The sheet has an array of at least four holes therethrough allowing the individual fingers of the user to pass through respective ones of the holes to an underside of the sheet adjacent to the rear face. The elasticity of the sheet allows the sheet to stretch away from the rear face to receive the fingers underneath the sheet.

### BACKGROUND OF THE INVENTION

This invention relates to a holder for a flat plate such as a tablet computer.

The recent introduction of tablet computers has achieved significant success so that many users have changed from the convention lap top portable computer to the tablet which is easier to carry and to read. Often it is the intention that the user hold the tablet for extended periods for reading of text.

One difficulty with such products is that they do not have a base which can be placed on a suitable support by which they present the screen at a suitable location and angle. Typically therefore the user is obliged to hold the tablet at the required angle.

The combination of the weight of an iPad, its thinness and its slippery casing make it difficult to grasp at the edges and quite easy to drop.

### SUMMARY OF THE INVENTION

It is one object of the invention to provide a holder which can be attached to a flat plate such as a tablet computer to allow the user to easily grasp and hold the tablet at a required position and angle so as to take the weight off the fingers of the user.

According to one aspect of the invention there is provided an apparatus for holding a flat plate having a rear face, a front face and a peripheral edge, such as a tablet computer, comprising:

a sheet of material shaped and arranged to lie flat adjacent to and parallel to the rear face of the flat plate;

an edge grip member arranged around the edge of the sheet and shaped to engage the edge of the plate to hold the sheet at the rear face;

the sheet extending over substantially the whole of the rear face;

the sheet having an array of at least four holes therethrough allowing the individual fingers of the user to pass through respective ones of the holes to an underside of the sheet adjacent to the rear face;

the sheet being formed of a flexible elastic material which is elastic to an extent to allow the sheet to stretch away from the rear face to receive the fingers underneath the sheet.

Preferably the sheet is a foam material and the foam sheet can have a thickness in the range 0.1 to 0.5 inch, preferably of the order of 0.25 inch.

In this way the sheet is of a soft flexible material so as to avoid presenting sharp edges to the fingers passing through the sheet.

Preferably the array of holes covers substantially the whole of the rear face so as to allow the hand and fingers to be placed at different positions across the rear of the plate.

Preferably the holes are in the range 0.5 to 1.5 inches in diameter.

Preferably the array of holes includes at least four rows each containing three or four holes.

Preferably there is provided a second sheet parallel to the elastic sheet and underlying the elastic sheet so as to form with the edge grip member a cover for the rear face.

Preferably the second sheet is fastened to the edge grip member with the elastic sheet covering the second sheet.

Preferably the second sheet is non-elastic, smooth and flat so that it remains flat against the rear face when the fingers are inserted through the holes.

Preferably the sheet is sufficiently elastic that the holes will stretch in size and position to allow the fingers to be forced through.

### BRIEF DESCRIPTION OF THE DRAWINGS

One embodiment of the invention will now be described in conjunction with the accompanying drawings in which:

FIG. 1 is a cross-sectional view of the holder according to the presnt invention.

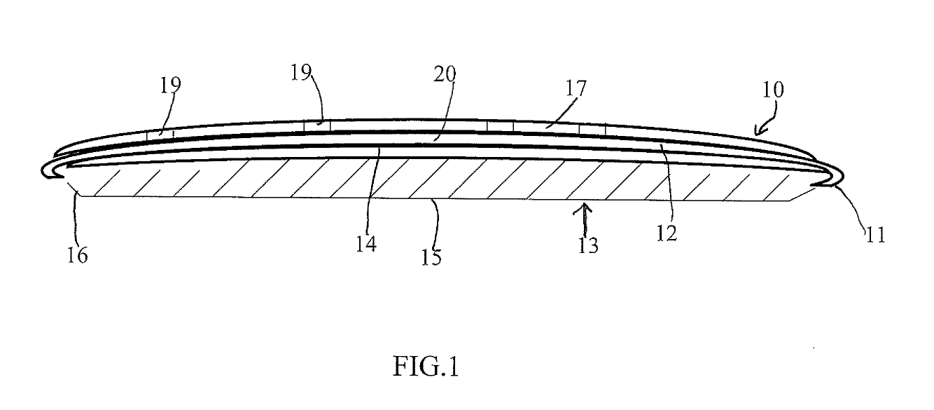

FIG. 2 is a rear elevational view of the holder of FIG. 2 showing the holes.

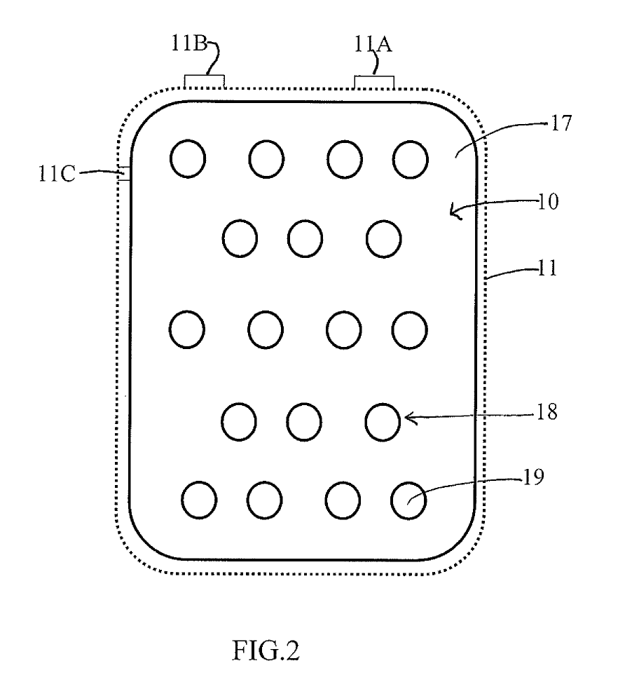

In the drawings like characters of reference indicate corresponding parts in the different figures.

### DETAILED DESCRIPTION

The apparatus 10 described herein is provided for holding a flat plate 13 such as a tablet computer. The tablet 13 (not shown to scale) has a rear face 14, a front face 15 and a peripheral edge 16. A back sheet 12 is provided to over the rear face 14 and includes an integral edge grip member 11 arranged around the edge of the back sheet and shaped to engage the edge 16 of the tablet to hold the sheet 12 at the rear face 14.

A further sheet 17 of material is shaped and arranged to lie flat adjacent to and parallel to the sheet 12 and therefore along the rear face of the flat plate. The sheet 17 extends over substantially the whole of the rear face. The sheet 17 has an array 18 of at least four holes 19 therethrough allowing the individual fingers of the user to pass through respective ones of the holes 19 to an underside 20 of the sheet 17 adjacent to the rear face 13 and contacting the surface of the sheet 12 which faces away from the tablet 13. The sheet 17 is formed of a flexible elastic foam material which is elastic to an extent to allow the sheet to stretch away from the rear face of the sheet 12 to receive the fingers underneath the surface 20 of the sheet 17.

Thus the user can grasp the tablet by inserting a number of fingers and optionally the thumb through selected ones of the array of holes to hold the tablet comfortably at a required angle relative to the hand. The provision of the array of more than four holes allows selection of the holes to locate the tablet at different orientations to the hand and wrist of the user. The underneath or second sheet 12 is optional and if provided is non-elastic, smooth and flat so that it remains flat against the rear face when the fingers are inserted through the holes.

Thus the array of holes covers substantially the whole of the rear face so as to allow the hand and fingers to be placed at different positions across the rear of the plate. Thus the array of holes will typically have at least four rows each containing three or four holes.

The sheet 17 is of any suitable soft flexible material so as to avoid presenting sharp edges to the fingers passing through the sheet and sufficiently elastic that the holes 18 will stretch in size and position to allow the fingers to be forced through at an angle required by the finger for suitable user comfort.

The holes 18 are typically in the range 0.5 to 1.5 inches in diameter and the foam sheet has a thickness typically in the range 0.1 to 0.5 inch.

The arrangement described herein provides a silicone or thermoplastic polyurethane type material case defined by the second sheet 17 and the edge grip member 11 that is impact-resistant and dense enough to protect the back and sides of the iPad from damage. This case 10 covers the back and thin sides but leaves the front uncovered except for a small frame around the screen defined by the edge 11. Attached to the back of the case is the stretchy material of the sheet 17, which can be for example, 2 mm double lined neoprene, with 15 to 20 holes 18 of the order of 2 cm in diameter, in which the iPad user can insert their fingers for additional gripping capacity.

The case adds approximately 8 oz and about 5 mm in thickness and length and almost 7 mm in width. All controls and ports are accessible while the iPad is in the case. The power/sleep button and volume rocker are covered by raised “bumps” in the iPad sleeve at the edge 11. There are openings 11C in the edge 11 for various inserted components such as for the headphone jack and microphone, an opening on the right side for the screen lock switch, and openings for the speaker and dock connector on the bottom.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus for holding a flat plate having a rear face, a front face and a peripheral edge, such as a tablet computer, comprising:
a sheet of material shaped and arranged to lie flat adjacent to and parallel to the rear face of the flat plate;
an edge grip member arranged around the edge of the sheet and shaped to engage the edge of the plate to hold the sheet at the rear face;
the sheet extending over substantially the whole of the rear face;
the sheet having an array of at least four holes therethrough allowing the individual fingers of the user to pass through respective ones of the holes to an underside of the sheet adjacent to the rear face;
the sheet being formed of a flexible elastic material which is elastic to an extent to allow the sheet to stretch away from the rear face to receive the fingers underneath the sheet.

2. The apparatus according to claim 1 wherein the sheet is a foam material.

3. The apparatus according to claim 2 wherein the foam sheet has a thickness in the range 0.1 to 0.5 inch.

4. The apparatus according to claim 1 wherein the sheet is of a soft flexible material so as to avoid presenting sharp edges to the fingers passing through the sheet.

5. The apparatus according to claim 1 wherein the array of holes covers substantially the whole of the rear face so as to allow the hand and fingers to be placed at different positions across the rear of the plate.

6. The apparatus according to claim 1 wherein the holes are in the range 0.5 to 1.5 inches in diameter.

7. The apparatus according to claim 1 wherein the array of holes includes at least four rows each containing three or four holes.

8. The apparatus according to claim 1 wherein there is provided a second sheet parallel to the elastic sheet and underlying the elastic sheet so as to form with the edge grip member a cover for the rear face.

9. The apparatus according to claim 8 wherein the second sheet is fastened to the edge grip member with the elastic sheet covering the second sheet.

10. The apparatus according to claim 8 wherein the second sheet is non-elastic, smooth and flat so that it remains flat against the rear face when the fingers are inserted through the holes.

11. The apparatus according to claim 1 wherein the sheet is sufficiently elastic that the holes will stretch in size and position to allow the fingers to be forced through.

12. The apparatus according to claim 1 including raised bumps in the edge grip member for switches on the edge of the plate.

13. The apparatus according to claim 1 including openings in the edge grip member for insertion of components through the holes into the edge of the plate.

14. The apparatus according to claim 1 including a tablet computer with the sheet of material flat adjacent to and parallel to the rear face of the tablet computer and the edge grip member engaged onto the edge of the tablet computer to hold the sheet at the rear face.
